(19) United States
(12) Patent Application Publication
(10) Pub. No.: US 2019/0200578 A1
(43) Pub. Date: Jul. 4, 2019

(54) BIRD WASTE DISPOSAL DEVICE FOR BIRDCAGE

(71) Applicant: Chin-Jung Chang, Hualien (TW)

(72) Inventor: Chin-Jung Chang, Hualien (TW)

(21) Appl. No.: 15/856,654

(22) Filed: Dec. 28, 2017

(51) Int. Cl. A01K 31/04; A01K 31/06; A01K 1/01; A01K 31/00

(52) U.S. Cl. CPC A01K 31/04; A01K 31/06; A01K 1/015; A01K 31/007; A01K 1/01

(57) ABSTRACT

A bird waste disposal device for a birdcage contains: a body and a holder which are removably connected together. The control module, an electrical cable, a motor control wire, a motor and a mixer are accommodated in the holder. The body is connected on the holder, the control module is accommodated in the holder, and power supplies to the control module via the electrical cable, wherein the control module controls the motor to rotate via the motor control wire, and the motor drives the mixer to revolve. Thereby, after birds discharge feces on the holder, the mixer is driven by the motor so as to mix the feces with sands in the holder, thus removing unpleasant smells and cleaning the feces.

### FIELD OF THE INVENTION

The present invention relates to a bird waste disposal device for a birdcage which mixes feces with sands in the holder so as to removes unpleasant smells and to clean the feces.

### BACKGROUND OF THE INVENTION

Conventional birdcage does not include a bird waste disposal device configured to removes unpleasant smells and to clean the feces.

The present invention has arisen to mitigate and/or obviate the afore-described disadvantages.

### SUMMARY OF THE INVENTION

The primary aspect of the present invention is to provide a bird waste disposal device for a birdcage which mixes feces with sands in the holder so as to removes unpleasant smells and to clean the feces.

To obtain the above aspect, a bird waste disposal device for a birdcage provided by the present invention contains: a body and a holder which are removably connected together.

The control module, an electrical cable, a motor control wire, a motor and a mixer are accommodated in the holder.

The body is connected on the holder, the control module is accommodated in the holder, and power supplies to the control module via the electrical cable, wherein the control module controls the motor to rotate via the motor control wire, and the motor drives the mixer to revolve.

Thereby, after birds discharge feces on the holder, the mixer is driven by the motor so as to mix the feces with sands in the holder, thus removing unpleasant smells and cleaning the feces.

### BRIEF DESCRIPTION OF THE DRAWINGS

FIG. 1 is a perspective view of exploded components of a bird waste disposal device for a birdcage according to a preferred embodiment of the present invention.

FIG. 2 is a perspective view of the operation of the bird waste disposal device for the birdcage according to the preferred embodiment of the present invention.

FIG. 3 is a perspective view of the assembly of the bird waste disposal device for the birdcage according to the preferred embodiment of the present invention.

### DETAILED DESCRIPTION OF THE PREFERRED EMBODIMENTS

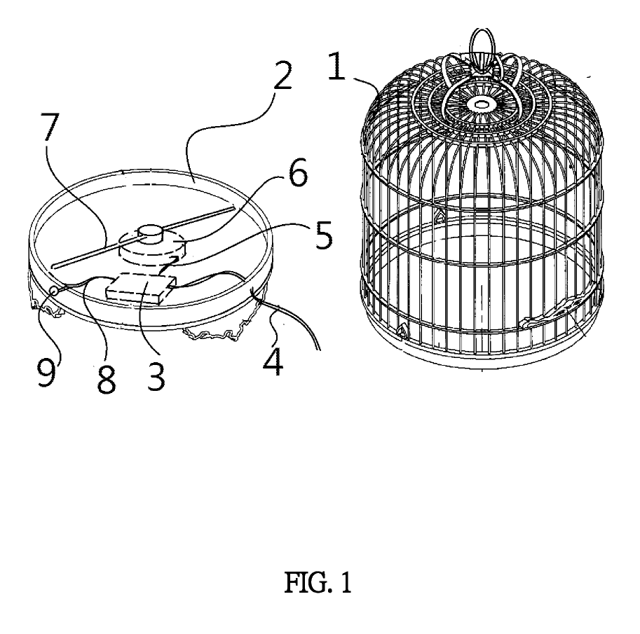

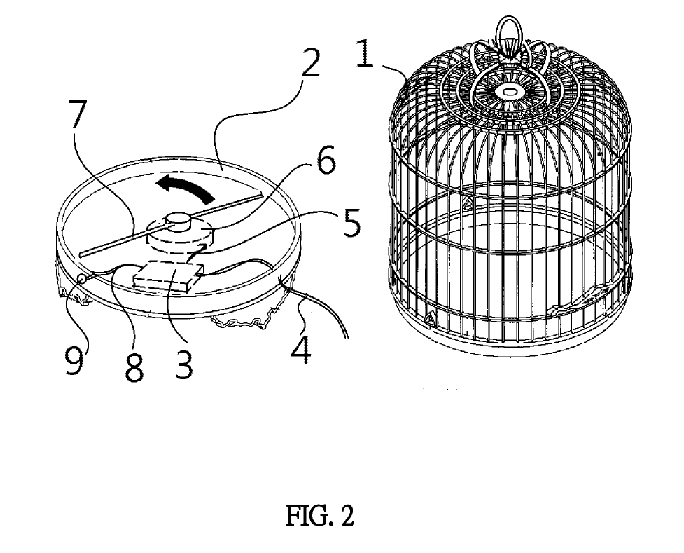

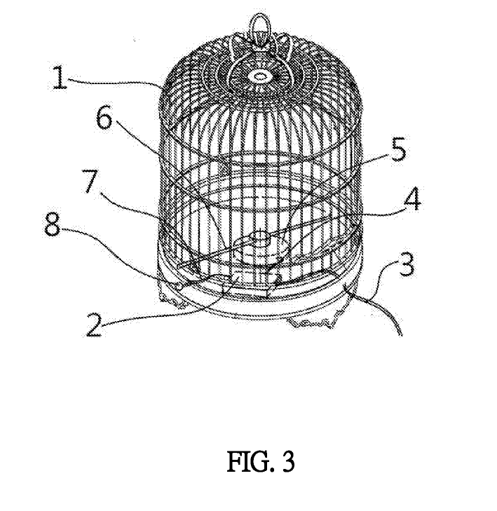

With reference to FIGS. 1 to 3, a bird waste disposal device for a birdcage according to a preferred embodiment of the present invention comprises: a body 1 and a holder 2 which are removably connected together, wherein a control module 3, an electrical cable 4, a motor control wire 5, a motor 6 and a mixer 7 are accommodated in the holder 2, and the control module 3 is electrically connected with a light sensor 9 via a signal cable 8.

The body 1 is connected on the holder 2, and the control module 3 is electrically connected with an indoor power supply or an external battery via the electrical cable 4, hence power supplies to the control module 3 from the indoor power supply or the external battery.

The control module 3 controls the motor 6 to rotate via the motor control wire 5, and the motor 6 drives the mixer 7 to revolve, hence after birds discharge feces on the holder 2, the mixer 7 is driven by the motor 6 so as to mix the feces with sands in the holder 2, thus removing unpleasant smells and cleaning the feces.

The control module 3 is started in an automatic operation mode or in a manual operation mode. Preferably, the control module 3 is electrically connected with the light sensor 9 via the signal cable 8 so as to provide a day starting mode or a night starting mode.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A bird waste disposal device for a birdcage comprising:
a body and a holder removably connected with the body;
a control module, an electrical cable, a motor control wire, a motor and a mixer accommodated in the holder;
wherein the body is connected on the holder, the control module is accommodated in the holder, and power supplies to the control module via the electrical cable, wherein the control module controls the motor to rotate via the motor control wire, and the motor drives the mixer to revolve.

2. The bird waste disposal device as claimed in claim 1, wherein the control module is electrically connected with a light sensor via a signal cable.

3. The bird waste disposal device as claimed in claim 1, wherein the control module is electrically connected with an indoor power supply.

4. The bird waste disposal device as claimed in claim 1, wherein the control module is electrically connected with an external battery.
